(19) United States
(12) Patent Application Publication
(10) Pub. No.: US 2025/0371590 A1
(43) Pub. Date: Dec. 4, 2025

(54) EXPENSE CALCULATION METHOD, ELECTRONIC DEVICE, AND STORAGE MEDIUM

(71) Applicants: Beijing Zitiao Network Technology Co., Ltd., Haidian District, Beijing (CN); Douyin Vision Co., Ltd., Shijingshan District, Beijing (CN)

(72) Inventors: Lv LIU, Beijing (CN); Zeyu ZHAN, Beijing (CN)

(21) Appl. No.: 18/874,509

(22) PCT Filed: Nov. 15, 2023
(86) PCT No.: PCT/CN2023/131772

§ 371 Date: Dec. 12, 2024

(30) Foreign Application Priority Data
Nov. 18, 2022 (CN) 202211449307.0

(51) Int. Cl. G06Q 30/04

(52) U.S. Cl. CPC G06Q 30/04

(57) ABSTRACT

Embodiments of the present disclosure provide an expense calculation method and apparatus, an electronic device, and a storage medium. The method includes: acquiring a preset expense calculation task associated with a target business object, and determining at least one expense calculation task item from the preset expense calculation task; reading data of an associated data item from a preset data table according to a preset calculation rule for the expense calculation task item; and completing the expense calculation task item based on the data of the associated data item and in accordance with the preset calculation rule, to complete the preset expense calculation task.

The present application claims the priority to Chinese Patent Application No. 202211449307.0, filed on Nov. 18, 2022, the entire disclosure of which is incorporated herein by reference as portion of the present application.

### TECHNICAL FIELD

Embodiments of the present disclosure relate to an expense calculation method and apparatus, an electronic device, a storage medium, and a product.

### BACKGROUND

Parties A and B having business interactions usually agree on relevant expense calculation rules for business processing based on business content, attributes and other business-related information, to realize business expense settlement between the parties A and B. However, for any business party, due to the diversification of business content and the diversification of business management modes, the complexity of the business-related expense calculation rules has increased significantly, and the simple calculation mode can no longer meet calculation function requirements of complex calculation scenarios.

### SUMMARY

The present disclosure provides an expense calculation method and apparatus, an electronic device, a storage medium, and a product, which enables an automatic expense calculation function application to be adaptable to more complex expense calculation scenarios, thus improving the efficiency of complex expense calculation.

Embodiments of the present disclosure provide an expense calculation method, which includes:
acquiring a preset expense calculation task associated with a target business object, and determining at least one expense calculation task item from the preset expense calculation task;
reading data of an associated data item from a preset data table according to a preset calculation rule for the expense calculation task item; and
completing the expense calculation task item based on the data of the associated data item and in accordance with the preset calculation rule, to complete the preset expense calculation task.

The embodiments of the present disclosure further provide an expense calculation apparatus, which includes:
a calculation task determination module, configured to acquire a preset expense calculation task associated with a target business object, and determine at least one expense calculation task item from the preset expense calculation task;
a calculation data acquisition module, configured to read data of an associated data item from a preset data table according to a preset calculation rule for the expense calculation task item; and
an expense calculation module, configured to complete the expense calculation task item based on the data of the associated data item and in accordance with the preset calculation rule, to complete the preset expense calculation task.

The embodiments of the present disclosure further provide an electronic device, which includes:
one or more processors; and
a storage apparatus, configured to store one or more programs;
the one or more programs, when executed by the one or more processors, enables the one or more processors to implement the expense calculation method according to any one of the embodiments of the present disclosure.

The embodiments of the present disclosure further provide a storage medium including computer-executable instructions, which, when executed by a computer processor, are used to perform the expense calculation method according to any one of the embodiments of the present disclosure.

The embodiments of the present disclosure further provide a computer program product, which includes a computer program, and the computer program, when executed by a processor, implements the expense calculation method according to any one of the embodiments of the present disclosure.

### BRIEF DESCRIPTION OF DRAWINGS

In conjunction with the drawings and with reference to the following detailed description, the above-mentioned and other features, advantages, and aspects of the various embodiments of the present disclosure will become more apparent. Throughout the drawings, the same or similar reference numerals denote the same or similar elements. It should be understood that the drawings are illustrative and the components and elements are not necessarily drawn to scale.

FIG. 1 is a schematic flowchart of an expense calculation method provided by the embodiments of the present disclosure;

FIG. 2 is a schematic flowchart of a royalty calculation method provided by the embodiments of the present disclosure;

FIG. 3 is a schematic flowchart of a royalty calculation method provided by the embodiments of the present disclosure;

FIG. 4 is a schematic structural diagram of an expense calculation apparatus provided by the embodiments of the present disclosure; and

FIG. 5 is a schematic structural diagram of an electronic device provided by the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

It may be understood that before using the technical solutions disclosed in the embodiments of the present disclosure, it is necessary to inform user(s) the types, using scope, and using scenarios of personal information involved in the present disclosure according to relevant laws and regulations in an appropriate manner and obtain the authorization of the user(s).

For example, in response to receiving a user's active request, a prompt message is sent to the user to clearly remind the user that the requested operation will require acquiring and using the user's personal information. Thus, users can selectively choose whether to provide personal information to the software or hardware such as an electronic device, an application, a server, or a storage medium that perform the operations of the technical solutions of the present disclosure according to the prompt message.

As an optional but non-restrictive implementation, in response to receiving the user's active request, sending the prompt message to the user may be done in the form of a pop-up window, where the prompt message may be presented in text. In addition, the pop-up window may further carry a selection control for users to choose between “agree” or “disagree” to provide the personal information to an electronic device.

It may be understood that the above-mentioned processes of informing and acquiring user authorization are only illustrative and do not limit the embodiments of the present disclosure. Other methods that comply with relevant laws and regulations may also be applied to the embodiments of the present disclosure.

It may be understood that the data involved in the technical solutions (including but not limited to the data itself, data acquisition or use) should comply with the requirements of corresponding laws, regulations and relevant provisions.

FIG. 1 is a schematic flowchart of an expense calculation method provided by the embodiments of the present disclosure. The embodiments of the present disclosure are applicable to calculation scenarios where there are many and complex expense calculation constraint items, and particularly applicable to royalty calculation scenarios for royalty objects such as music. This method may be performed by an expense calculation apparatus. This apparatus may be implemented in the form of software and/or hardware, and optionally, by an electronic device. The electronic device may be a mobile terminal, a PC, a server, or the like.

As shown in FIG. 1, the expense calculation method includes the following steps.

S110: acquiring a preset expense calculation task associated with a target business object, and determining at least one expense calculation task item from the preset expense calculation task.

Herein, the target business object is a business party object that has a business interaction with a user of an expense calculation apparatus and is required to perform business-related expense settlement. The preset expense calculation task may be a calculation task generated based on a pre-agreed expense calculation rule between the user and the target business object. The preset expense calculation task needs to be configured manually, automatically or semi-automatically on an expense calculation configuration interface in the expense calculation apparatus before the calculation is performed.

For complex expense calculation scenarios, different billing objects, different billing dimensions, and different billing scenario conditions usually correspond to different billing rules. Therefore, one preset expense calculation task contains at least one expense calculation task item, and each expense calculation task item corresponds to a calculation rule derived from parsing a preset expense calculation task. The preset expense calculation task includes at least one selected from a group consisting of a labor expense calculation task, a project fund calculation task, and a royalty calculation task.

The acquiring the preset expense calculation task associated with the target business object may include: acquiring an expense calculation constraint file number associated with the target business object first; and then querying the preset expense calculation task according to the expense calculation constraint file number. Further, at least one expense calculation task item from the preset expense calculation task may be determined. For example, an expense calculation constraint file may be a business contract established by two parties that have a business interaction relationship, and the business-related expense calculation rules are agreed upon in the contract. Accordingly, the expense calculation task item may be an expense calculation task formula determined based on at least one constraint item specified in the expense calculation constraint file. The constraint item may be a calculation data item within the calculation rules. Multiple expense calculation task items within one expense calculation task may be understood as organizing and decomposing the complex expense calculation rules and scenarios.

S120: reading data of an associated data item from a preset data table according to a preset calculation rule for the expense calculation task item.

Herein, the preset data table includes an original data table and a data intermediate table that has undergone data processing. For example, the original data table may be a calculation constraint data table determined by data in the expense calculation constraint file, an attribute information table of billing objects, and the like. The data intermediate table may include a calculation constraint item of each expense calculation task, in which the data content is a statistical result or a data filtering result. That is, in the embodiments of the present disclosure, the calculation constraint data items used in the expense calculation process is managed in the manner of a preset data table.

It should be understood that the data intermediate table may be a data table that is dynamically maintained based on the progress of a business with the target business object. The timeliness of the data intermediate table may be maintained in a way that it is updated periodically at regular intervals, thereby ensuring the accuracy of the expense calculation task results.

Specifically, the data of the data items required in the calculation process may be read from the respective preset data tables according to a specific calculation rule for each expense calculation task item. For example, target billing object consumption data associated with the expense calculation task item is read from a billing object consumption data statistical table according to the preset calculation rule. A data item associated with the expense calculation task item is read from a preset expense calculation constraint data table according to the preset calculation rule; and the preset expense calculation constraint data table is a collection of calculation rule constraint data items determined based on expense calculation details specified in the expense calculation constraint file associated with the target business object. Information of a billing object associated with the target business object is read from a preset billing object information table according to the preset calculation rule; and the information of the billing object includes billing attribute information of the billing object.

S130: completing the expense calculation task item based on the data of the associated data item and in accordance with the preset calculation rule, to complete the preset expense calculation task.

According to the specific calculation rule of each expense calculation task item and the read data, the corresponding expense calculation process is completed, i.e., the combination of the consumption data of the billing object, the content of the expense calculation constraint file and the calculation rule in a business is achieved, and the preset expense calculation task can be completed automatically and efficiently.

The technical solution of the embodiment includes: acquiring a preset expense calculation task associated with a target business object, and determining at least one expense calculation task item from the preset expense calculation task; reading data of an associated data item from a preset data table according to a preset calculation rule for the expense calculation task item; and completing the expense calculation task item based on the data of the associated data item and in accordance with the preset calculation rule, to complete the preset expense calculation task. That is, with the solution of the embodiments of the present disclosure, a complex expense calculation task is decomposed into different task items, which are applicable to different calculation rules; and besides, data that needs to be used for the expense calculation is preprocessed, so that the relevant data may be read on demand during the calculation process, and the relevant expense calculation may be quickly completed. The technical solution of the embodiments of the present disclosure solves the issue of mismatch between the automatic expense calculation function and the calculation requirements, is applicable to more complex expense calculation scenarios, and improves the efficiency of complex expense calculation.

Because music royalty calculation is a complex expense calculation scenario in a streaming media application scenario, then, to better demonstrate the fact that the expense calculation method in the embodiments of the present disclosure is applicable to various complex expense calculation scenarios, the complex expense calculation process is illustrated in the embodiments of the present disclosure by taking royalty calculation as an example.

In the embodiments of the present disclosure, in response to the expense calculation task being a royalty calculation task, the expense calculation constraint file may be a royalty contract, the configuration interface for the user to perform expense calculation may be a royalty calculation configuration interface, the expense calculation configuration operation may be a royalty calculation configuration operation, the expense calculation task item may be a royalty calculation task item, and the billing object is a royalty object correspondingly.

Royalties refer to a certain monetary share obtained by copyright holders when others use their works. Some applications may provide users with music works to play or use, and accordingly, the application platform needs to pay royalties to copyright holders of the music works. At present, the automatic settlement process for music royalties is based on the number of times a music work is played or used by users on the application platform and the fee per play. However, with the diversification of application scenarios within the application and the diversification of operation modes of the application platform, the royalty calculation process has become complex and the volume of data processing has increased. In some cases, the calculation mode is unable to support the requirements of complex royalty calculation function.

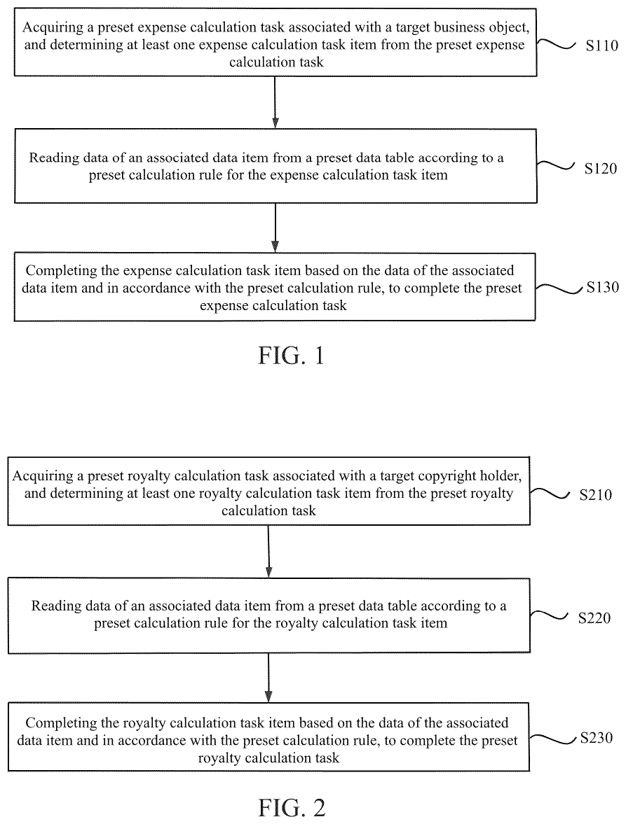

Further, FIG. 2 is a schematic flowchart of a royalty calculation method provided by the embodiments of the present disclosure. The embodiment of the present disclosure is applicable to complex royalty calculation scenarios within streaming media application scenarios, and particularly applicable to royalty calculation scenarios for royalty objects such as music. This method may be performed by a royalty calculation apparatus. This apparatus may be implemented in the form of software and/or hardware, and optionally, by an electronic device. The electronic device may be a mobile terminal, a PC, a server, or the like.

As shown in FIG. 2, the royalty calculation method includes the following steps.

S210: acquiring a preset royalty calculation task associated with a target copyright holder, and determining at least one royalty calculation task item from the preset royalty calculation task.

For example, some application platforms may provide platform users with content such as music works, literary works or movie and television works in application scenarios such as live streaming, short video or Karaoke. Users may browse and play various works, or edit them into short video content as materials. A copyright holder is the copyright owner of the work content provided in the platform. The application platform needs to pay copyright usage fees, i.e., royalties, for each work it uses. The target copyright holder refers to a copyright holder for whom various royalty settlements currently need to be conducted.

The preset royalty calculation task is a royalty calculation task determined according to a purchase contract signed between the application platform and the target copyright holder for each work. The details of the royalty expense calculation for the respective copyright objects (i.e., the music works, movie or television works, or literary paintings and calligraphy being purchased) are specified in the purchase contract. It may be understood that the details of royalty expense calculation are the specific task content of the royalty calculation task.

Taking the music works as an example, in previous short video scenario, music royalty calculation often involved simple multiplication, such as multiplying the number of times a platform user using a copyright object to produce short video content by the fee per use. However, in streaming media scenarios, the royalty calculation rules are more complex and typically involve setting different calculation rules based on various data items in the contract details, different commercialization modes, different platform user statuses (paid users and free users), and different calculation dimensions. By organizing the contract details, each calculation rule corresponds to a royalty calculation task item within the royalty calculation task. For example, a royalty settlement mode for the paid users is that the greater of two calculation results from a membership income mode and a fixed share mode is taken as a final result. The calculation details involved in membership income are divided into two categories. The first category includes payment channels, taxes and fees in various countries, and currency/exchange rate conversions between countries, where each copyright holder usually has different reduction and exemption logics for channels and taxes and fees. The second category includes promotional activities and product discounts for members, which will affect the settlement formula and the exemption and exemption logic. Therefore, each royalty calculation task usually includes multiple royalty calculation task items.

Specifically, when a royalty calculation task is started, the target copyright holder corresponding to the royalty calculation task is first acquired. Then, a royalty contract number associated with the target copyright holder may be acquired based on identification information of the target copyright holder. Thus, the preset royalty calculation task is queried based on the royalty contract number, and at least one royalty calculation task item from the preset royalty calculation task is determined.

The royalty calculation task item is a royalty calculation task formula determined based on the detail content such as the business scenario, the type of royalty object, the royalty payment mode, the royalty payment region, the platform advertisement mode, the user charging mode, the user charging channel, the user preferential policy, and the payment currency specified in the royalty contract of the target copyright holder. Each royalty calculation task item may be preconfigured in the royalty calculation apparatus in accordance with the royalty contract details, for example, a royalty calculation formula applicable to the membership mode, a royalty calculation formula applicable to the advertisement mode, a royalty calculation formula applicable to albums/singles, a CV (Content Views) usage calculation formula applicable to short videos, and a music and lyrics royalty calculation formula applicable to singles.

The royalty calculation task may be started at regular intervals according to a preset royalty calculation cycle, or the royalty calculation task may be actively triggered by a user of a royalty calculation system.

S220: reading data of an associated data item from a preset data table according to a preset calculation rule for the royalty calculation task item.

The associated data item may be a calculation constraint data item required for calculation rules of each royalty calculation task item.

The associated data item may be roughly divided into three categories.

The first category of data includes financial data determined based on the royalty contract, such as settlement scenario, royalty type, minimum guaranteed amount, unit price per play of the copyright object, taxes and fees and currency of various countries, payment region code, channel fees of the payment channel, the settlement amount, effective start time, and effective end time of the royalty preset settlement cycle of the copyright holder, and the consolidation logic of multiple minimum guarantees. This type of data may be determined by manual system entry based on the content of the royalty contract, or may be acquired by contract text recognition.

The second category of data includes platform user's consumption data (usage data) on copyright objects, such as playback regions, view counts, total view counts, the number of clicks, and duration per play. This type of data may be acquired from the traffic consumption data of the platform application and stored in a corresponding data table.

The third category of data includes content information (content data) of copyright objects, which corresponds to attribute information of billing objects, including the name of each royalty object, the attribution of the copyright holder, and the royalty ratio of the content of the royalty object. Different categories of data items are stored in different data tables within the data warehouse, respectively.

During data reading, the storage location of the respective associated data items may be determined based on index information corresponding thereto, so as to perform the data reading.

S230: completing the royalty calculation task item based on the data of the associated data item and in accordance with the preset calculation rule, to complete the preset royalty calculation task.

After the respective data items are acquired, they may be calculated in accordance with the preset calculation rule. The calculation logics between the respective data items include the calculation of different arithmetic functions such as adding, subtracting, multiplying, dividing, taking maximum or minimum value. In addition, some literals, such as fixed characters and constant values may also be included in the calculation formulas corresponding to the respective royalty calculation task items. For numeric types, it is sufficient to use numbers directly; and for string types, it is necessary to surround them with single or double quotation marks.

By processing the respective royalty calculation task items, the data of different data tables are collected, thus integrating the “consumption data” with the “royalty financial data”, achieving the automatic clearing of the amount required for the purchase of copyright objects, and improving the efficiency of royalty calculation.

The technical solution of the embodiment includes: after acquiring a preset royalty calculation task associated with a target copyright holder, determining at least one royalty calculation task item from the preset royalty calculation task; then, reading data of an associated data item from a preset data table according to a preset calculation rule for the royalty calculation task item; and completing the royalty calculation task item based on the read data of the associated data item and in accordance with the preset calculation rule, to complete the preset royalty calculation task. That is, with the solution of the embodiment of the present disclosure, a royalty calculation task is decomposed into different task items, which are applicable to different calculation rules; and besides, data required for the royalty calculation is integrated in advance, so that the relevant data may be read on demand during the calculation process, and the royalty calculation may be quickly completed. The technical solution of the embodiments of the present disclosure solves the issue of mismatch between the royalty calculation function and the calculation requirements, is applicable to the complex royalty calculation process of streaming media in multiple application scenarios, and improves the efficiency of royalty calculation.

FIG. 3 is a schematic flowchart of yet another royalty calculation method provided by the embodiments of the present disclosure. In the process of implementing the method, the process of aggregating consumption data for the royalty objects is further described. The method may be performed by a royalty calculation apparatus. This apparatus may be implemented in the form of software and/or hardware, optionally, by an electronic device. The electronic device may be a mobile terminal, a PC, or a server, or the like.

As shown in FIG. 3, the royalty calculation method includes the following steps.

S310: acquiring a preset royalty calculation task associated with a target copyright holder, and determining at least one royalty calculation task item from the preset royalty calculation task.

S320: acquiring an original consumption record data table of a royalty object in each royalty calculation task item, and performing, based on a preset business scenario and a preset data statistical dimension corresponding to the royalty calculation task item, statistics of valid consumption record data on consumption record data in the original consumption record data table respectively to obtain a consumption data statistical table of the royalty object.

Herein, the original consumption record data table is a data table recorded by the application platform during browsing, playing, or editing of each copyright object. For example, the original consumption record data table may include information such as the identifier of each copyright object, the copyright holder to which it belongs, the business scenario used, the member/non-member playing path, the time used, and the playing or browsing duration.

However, the consumption record data of different upstream businesses may have different table names and table structures in the data warehouse. In order to enable a royalty settlement system to carry out data reading and calculation in a unified manner and to efficiently recognize data in data tables with different table structures, by this step, an intermediate layer (intermediate table) may be established between the original consumption record data of the business and the settlement system, to process the original consumption record data of different businesses and the inherent attributes (e.g., word ratio and tune ratio) of the royalty object itself and other information that need to be used in the calculation, thereby obtaining a unified table structure for the settlement system to process.

With respect to the intermediate table of consumption record data, i.e., the consumption data statistical table of the royalty object determined in this step, the original consumption record data may be aggregated and processed in accordance with the requirements of different calculation rules upon the preset business scenarios in which the copyright object is used and the preset data statistical dimensions. For example, in the statistics of playing count, the playing count of single playing of more than 30 seconds is to be counted, which requires to filter data of the original consumption record data according to the playing duration, to finally obtain a data statistical result of the playing duration longer than 30 seconds as the content of a data item in the consumption record data intermediate table. The data statistics may further include statistical information such as the percentage of playing count of a royalty object to the overall playing count of similar royalty objects.

For example, the implementation of the task of maintaining the consumption data statistical table for the royalty objects may be achieved by creating a Dorado task. The statistical rules or filtering rules in the data statistics or filtering may be preconfigured according to the calculation requirements of different calculation rules as a task execution logic of Dorado presentation middleware.

The Dorado presentation middleware enables comprehensive Web presentation layer development, facilitating the presentation of data, charts, documents, and reports, as well as implementing data creation, deletion, modification, and querying. It offers high performance and can enhance the calculation efficiency of the royalty calculation system.

S330: reading a data item associated with the royalty calculation task item from a preset royalty calculation ledger data table according to the preset calculation rule, reading information of the royalty object associated with the target copyright holder from a preset royalty object information table, and reading consumption data of the target royalty object associated with the task item from the royalty object consumption data statistical table.

Herein, the preset royalty calculation ledger data table refers to financial data determined based on the royalty contract, such as settlement scenario, royalty type, minimum guaranteed amount, unit price per play of the copyright object, taxes and fees and currency of various countries, payment region code, channel fees of the payment channel, the settlement amount, effective start time, and effective end time of the royalty preset settlement cycle of the copyright holder, and the consolidation logic of multiple minimum guarantees. This type of data may be determined by manual system entry based on the content of the royalty contract, or may be acquired by contract text recognition. The preset royalty object information table refers to content information (content data) of copyright objects, including the name of each royalty object, the attribution of the copyright holder, and the royalty ratio of the content of the royalty object. Different categories of data items are stored in different data tables within the data warehouse. The royalty object consumption data statistical table is an intermediate table obtained by data processing in the above steps.

By defining the business meaning of the data tables and data items in the royalty calculation system in advance, the data items in respective data tables may be read and operated more easily, thereby achieving compatibility data between data tables.

S340: completing the royalty calculation task item based on the data read in the above-mentioned steps and in accordance with the preset calculation rule, to complete the preset royalty calculation task.

The process of calculating the data according to the calculation rule of each royalty calculation task item may be understood as a process of integrating and managing the royalty contract, the financial data, and the settlement formulas through a royalty calculation module. The corresponding royalty calculation results may be obtained by calculating the content of the read data items according to the calculation rules of the respective royalty calculation task items.

S350: summarizing royalty data from the royalty calculation results of the respective royalty calculation task items to obtain a royalty data summary result, and pushing the royalty data summary result to a data settlement processing entry or a data report processing entry.

In a royalty calculation task, after the processing of the respective royalty calculation task items is completed, the calculation results of the respective task items may be summarized, analyzed and displayed, and then are integrated to obtain the summary results of the respective royalty calculation task items. Because the reporting fields and format requirements of royalty calculation results of different copyright holders are different, the summary result may be filled into a reporting template that matches the target copyright object to perform summary report of royalty calculation.

The settlement processing entry is an interface connected between a financial system and a royalty calculation system. The royalty data summary result may be sent to the financial system through the settlement processing entry such that the financial system carries out the financial settlement based on the royalty data calculation results. The data report processing entry may be an interface for reporting the royalty data summary result to the target copyright holder, for example, sending a report to the copyright holder by means of SFTP (Secure File Transfer Protocol)/email. By this step, the automatic processing of the entire process from the start of royalty task processing to the reporting and settlement of the royalty calculation results may be implemented.

The technical solution of the embodiment of the present disclosure includes: after acquiring a preset royalty calculation task associated with a target copyright holder, determining at least one royalty calculation task item from the preset royalty calculation task; then acquiring an original consumption record data table of a royalty object in each royalty calculation task item, and performing, based on a preset business scenario and a preset data statistical dimension corresponding to the royalty calculation task item, statistics of valid consumption record data on consumption record data in the original consumption record data table respectively to obtain a consumption data statistical table of the royalty object; reading data items associated with the royalty calculation task items from the preset royalty calculation ledger data table, the preset royalty object information table, and the royalty object consumption data statistical table according to the preset calculation rule, completing the royalty calculation task item in accordance with the preset calculation rule to complete the preset royalty calculation task; and summarizing royalty data and pushing the royalty data summary result to a data settlement processing entry or a data report processing entry. That is, with the solution of the embodiment of the present disclosure, a royalty calculation task is decomposed into different task items, which are applicable to different calculation rules; and besides, an intermediate table is created to perform statistics on the royalty consumption record data in advance, so that the format of various data tables is standardized, the arithmetic logic of the royalty calculation process is clearer and the calculation is more efficient, and the royalty calculation is completed quickly. The technical solution of the embodiments of the present disclosure solves the issue of mismatch between the royalty calculation function and the calculation requirements, is applicable to the complex royalty calculation process of streaming media in multiple-application scenarios, and improves the efficiency of royalty calculation.

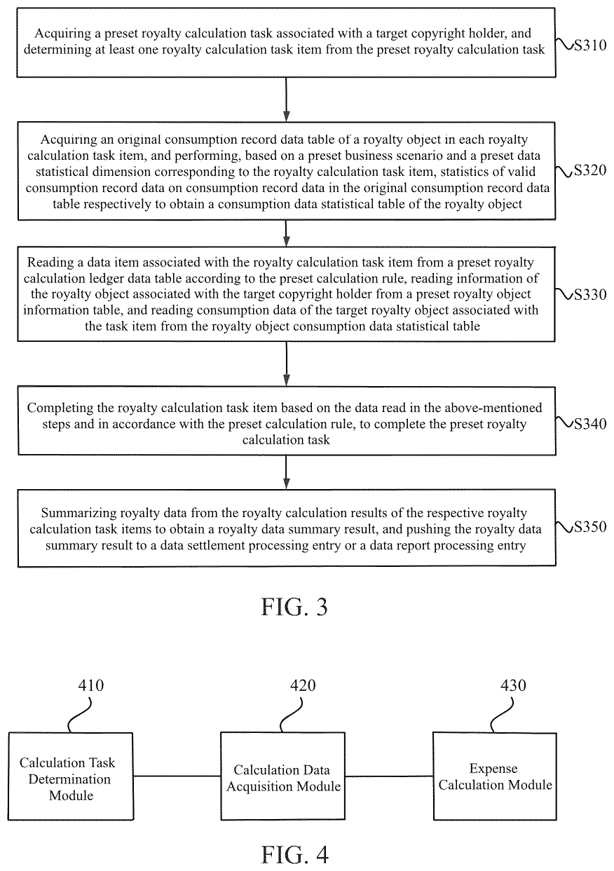

FIG. 4 is a schematic structural diagram of an expense calculation apparatus provided by the embodiments of the present disclosure. This apparatus is applicable to calculation scenarios where there are many and complex expense calculation constraint items, and particularly applicable to royalty calculation scenarios for royalty objects such as music. The expense calculation apparatus may be implemented in the form of software and/or hardware, and may be configured in an electronic device. The electronic device may be a mobile terminal, a PC, a server, or the like.

As shown in FIG. 4, the expense calculation apparatus includes a calculation task determination module 410, a calculation data acquisition module 420, and an expense calculation module 430.

The calculation task determination module 410 is configured to acquire a preset expense calculation task associated with a target business object, and determine at least one expense calculation task item from the preset expense calculation task. The calculation data acquisition module 420 is configured to read data of an associated data item from a preset data table according to a preset calculation rule for the expense calculation task item. The expense calculation module 430 is configured to complete the expense calculation task item based on the data of the associated data item and in accordance with the preset calculation rule, to complete the preset expense calculation task.

The technical solution of the embodiment includes: acquiring a preset expense calculation task associated with a target business object, and determining at least one expense calculation task item from the preset expense calculation task; reading data of an associated data item from a preset data table according to a preset calculation rule for the expense calculation task item; and completing the expense calculation task item based on the data of the associated data item and in accordance with the preset calculation rule, to complete the preset expense calculation task. That is, with the solution of the embodiments of the present disclosure, a complex expense calculation task is decomposed into different task items, which are applicable to different calculation rules; and besides, data that needs to be used for the expense calculation is preprocessed, so that the relevant data may be read on demand during the calculation process, and the relevant expense calculation may be quickly completed. The technical solution of the embodiments of the present disclosure solves the issue of mismatch between the automatic expense calculation function and the calculation requirements, is applicable to more complex expense calculation scenarios, and improves the efficiency of complex expense calculation.

Based on any one of the optional technical solutions in the embodiments of the present disclosure, optionally, the calculation data acquisition module 420 is configured to:
read target billing object consumption data associated with the expense calculation task item from a billing object consumption data statistical table according to the preset calculation rule.

Based on any one of the optional technical solutions in the embodiments of the present disclosure, optionally, the calculation data acquisition module 420 is further configured to:
read a data item associated with the expense calculation task item from a preset expense calculation constraint data table according to the preset calculation rule;
where the preset expense calculation constraint data table is a collection of calculation rule constraint data items determined based on expense calculation details specified in an expense calculation constraint file associated with the target business object.

Based on any one of the optional technical solutions in the embodiments of the present disclosure, optionally, the calculation data acquisition module 420 is further configured to:
read information of a billing object associated with the target business object from a preset billing object information table according to the preset calculation rule;
where the information of the billing object includes billing attribute information of the billing object.

Based on any one of the optional technical solutions in the embodiments of the present disclosure, optionally, the expense calculation apparatus further includes a data aggregation module configured to calculate based on the original consumption data of the billing object to generate a billing object consumption data table.

The data aggregation module may be configured to:
acquire an original consumption record data table of each billing object;
perform statistics of valid consumption record data on original consumption record data in the original consumption record data table, respectively, based on a preset business scenario and a preset data statistical dimension; and
fill in preset list items in the billing object consumption data table based on statistical results of the valid consumption record data to obtain the billing object consumption data statistical table.

Based on any one of the optional technical solutions in the embodiments of the present disclosure, optionally, the calculation task determination module 410 is configured to:
acquire an expense calculation constraint file number associated with the target business object;
and query the preset expense calculation task according to the expense calculation constraint file number, and determine at least one expense calculation task item from the preset expense calculation task;
where the expense calculation task item is an expense calculation task formula determined based on at least one constraint item specified in an expense calculation constraint file.

Based on any one of the optional technical solutions in the embodiments of the present disclosure, optionally, the expense calculation apparatus further includes an expense data summary module configured to:
summarize expense data from expense calculation results of respective expense calculation task items to obtain an expense data summary result;
and push the expense data summary result to a data settlement processing entry or a data report processing entry.

Based on any one of the optional technical solutions in the embodiments of the present disclosure, optionally, the preset expense calculation task includes at least one selected from a group consisting of a labor expense calculation task, a project fund calculation task, and a royalty calculation task.

The above-mentioned expense calculation apparatus provided by the embodiments of the present disclosure can perform the expense calculation method provided by any embodiment of the present disclosure, and has functional modules and advantageous effects corresponding to the method performed.

It is noteworthy that the units and modules included in the above-mentioned apparatus are divided according to functional logic and are not limited to such divisions, as long as the corresponding functions can be realized. Furthermore, the specific names of the functional units are merely for the purpose of differentiation and are not intended to limit the scope of protection of the embodiments of the present disclosure.

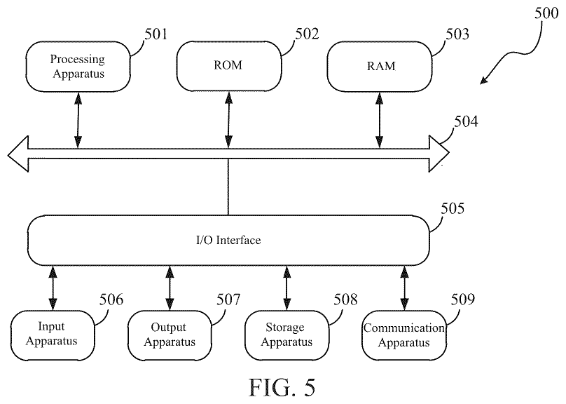

FIG. 5 is a schematic structural diagram of an electronic device provided by the embodiments of the present disclosure. With reference to FIG. 5, it shows a schematic structural diagram of an electronic device 500 (e.g., a terminal device or server in FIG. 5) suitable for implementing the embodiments of the present disclosure. The electronic device in the embodiments of the present disclosure may include but is not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), or the like, and a fixed terminal such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected through a bus 504. An input/output (I/O) interface 505 is also connected to the bus 504.

Usually, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The names of the messages or information exchanged between a plurality of apparatuses in the embodiments of the present disclosure are for illustrative purposes only and are not intended to limit the scope of these messages or information.

The electronic device provided by the embodiments of the present disclosure and the expense calculation method provided by the above embodiments belong to the same inventive concept, and technical details not exhaustively described in the present embodiment may be referred to the above embodiments, and the present embodiment has the same beneficial effects as the above embodiments.

The embodiments of the present disclosure further provide a computer-readable storage medium on which a computer program is stored. When executed by a processor, the program implements the expense calculation method provided by the above-mentioned embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
acquire a preset expense calculation task associated with a target business object, and determine at least one expense calculation task item from the preset expense calculation task;
read data of an associated data item from a preset data table according to a preset calculation rule for the expense calculation task item; and
complete the expense calculation task item based on the data of the associated data item and in accordance with the preset calculation rule, to complete the preset expense calculation task.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances. For example, a first acquisition unit may also be described as a “unit for acquiring at least two internet protocol addresses.”

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The embodiments of the present disclosure further provide a computer program product including a computer program, which, when executed by a processor, implements the expense calculation method provided by any embodiment of the present disclosure.

In the process of implementing the computer program product, the computer program code for performing the operations of the present disclosure may be written in one or more programming languages or a combination thereof. The above-mentioned programming languages include object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

According to one or more embodiments of the present disclosure, example 1 provides an expense calculation method, which includes:
acquiring a preset expense calculation task associated with a target business object, and determining at least one expense calculation task item from the preset expense calculation task;
reading data of an associated data item from a preset data table according to a preset calculation rule for the expense calculation task item; and
completing the expense calculation task item based on the data of the associated data item and in accordance with the preset calculation rule, to complete the preset expense calculation task.

According to one or more embodiments of the present disclosure, example 2 provides an expense calculation method, which further includes:
in some optional implementations, the reading data of the associated data item from the preset data table according to the preset calculation rule for the expense calculation task item includes:
reading target billing object consumption data associated with the expense calculation task item from a billing object consumption data statistical table according to the preset calculation rule.

According to one or more embodiments of the present disclosure, example 3 provides an expense calculation method, which includes:
in some optional implementations, the reading data of the associated data item from the preset data table according to the preset calculation rule for the expense calculation task item further includes:
reading a data item associated with the expense calculation task item from a preset expense calculation constraint data table according to the preset calculation rule,
where the preset expense calculation constraint data table is a collection of calculation rule constraint data items determined based on expense calculation details specified in an expense calculation constraint file associated with the target business object.

According to one or more embodiments of the present disclosure, example 4 provides an expense calculation method, which further includes:
in some optional implementations, the reading data of the associated data item from the preset data table according to the preset calculation rule for the expense calculation task item further includes:
reading information of a billing object associated with the target business object from a preset billing object information table according to the preset calculation rule,
where the information of the billing object includes billing attribute information of the billing object.

According to one or more embodiments of the present disclosure, example 5 provides an expense calculation method, which further includes:
in some optional implementations, a process of determining the billing object consumption data statistical table includes:
acquiring an original consumption record data table of each billing object;
performing statistics of valid consumption record data on original consumption record data in the original consumption record data table, respectively, based on a preset business scenario and a preset data statistical dimension; and
filling in preset list items in the billing object consumption data table based on statistical results of the valid consumption record data to obtain the billing object consumption data statistical table.

According to one or more embodiments of the present disclosure, example 6 provides an expense calculation method, which further includes:
in some optional implementations, the acquiring the preset expense calculation task associated with the target business object, and determining at least one expense calculation task item from the preset expense calculation task includes:
acquiring an expense calculation constraint file number associated with the target
business object; and
querying the preset expense calculation task according to the expense calculation constraint file number, and determining at least one expense calculation task item from the preset expense calculation task,
where the expense calculation task item is an expense calculation task formula determined based on at least one constraint item specified in an expense calculation constraint file.

According to one or more embodiments of the present disclosure, example 7 provides an expense calculation method, which further includes:
in some optional implementations, the method further includes:
summarizing expense data from expense calculation results of respective expense calculation task items to obtain an expense data summary result; and
pushing the expense data summary result to a data settlement processing entry or a data report processing entry.

According to one or more embodiments of the present disclosure, example 8 provides an expense calculation method, which further includes:
in some optional implementations, the preset expense calculation task includes at least one selected from a group consisting of a labor expense calculation task, a project fund calculation task, and a royalty calculation task.

According to one or more embodiments of the present disclosure, example 9 provides an expense calculation apparatus, which includes:
a calculation task determination module, configured to acquire a preset expense calculation task associated with a target business object, and determine at least one expense calculation task item from the preset expense calculation task;
a calculation data acquisition module, configured to read data of an associated data item from a preset data table according to a preset calculation rule for the expense calculation task item; and
an expense calculation module, configured to complete the expense calculation task item based on the data of the associated data item and in accordance with the preset calculation rule, to complete the preset expense calculation task.

According to one or more embodiments of the present disclosure, example 10 provides an expense calculation apparatus, which further includes:
in some optional implementations, the calculation data acquisition module is configured to:
read target billing object consumption data associated with the expense calculation task item from a billing object consumption data statistical table according to the preset calculation rule.

According to one or more embodiments of the present disclosure, example 11 provides an expense calculation apparatus, which further includes:
in some optional implementations, the calculation data acquisition module is further configured to:
read a data item associated with the expense calculation task item from a preset expense calculation constraint data table according to the preset calculation rule,
where the preset expense calculation constraint data table is a collection of calculation rule constraint data items determined based on expense calculation details specified in an expense calculation constraint file associated with the target business object.

According to one or more embodiments of the present disclosure, example 12 provides an expense calculation apparatus, which further includes:
in some optional implementations, the calculation data acquisition module is further configured to:
read information of a billing object associated with the target business object from a preset billing object information table according to the preset calculation rule,
where the information of the billing object includes billing attribute information of the billing object.

According to one or more embodiments of the present disclosure, example 13 provides an expense calculation apparatus, which further includes:
in some optional implementations, the expense calculation apparatus further includes a data aggregation module configured to calculate based on the original consumption data of the billing object to generate a billing object consumption data table.

The data aggregation module may be configured to:
acquire an original consumption record data table of each billing object;
perform statistics of valid consumption record data on original consumption record data in the original consumption record data table, respectively, based on a preset business scenario and a preset data statistical dimension; and
fill in preset list items in the billing object consumption data table based on statistical results of the valid consumption record data to obtain the billing object consumption data statistical table.

According to one or more embodiments of the present disclosure, example 14 provides an expense calculation apparatus, which further includes:
in some optional implementations, the calculation task determination module is configured to:
acquire an expense calculation constraint file number associated with the target business object;
and query the preset expense calculation task according to the expense calculation constraint file number, and determine at least one expense calculation task item from the preset expense calculation task;
where the expense calculation task item is an expense calculation task formula determined based on at least one constraint item specified in an expense calculation constraint file.

According to one or more embodiments of the present disclosure, example 15 provides an expense calculation apparatus, which further includes:
in some optional implementations, the expense calculation apparatus further includes an expense data summary module configured to:
summarize expense data from expense calculation results of respective expense calculation task items to obtain an expense data summary result;
and push the expense data summary result to a data settlement processing entry or a data report processing entry.

According to one or more embodiments of the present disclosure, example 16 provides an expense calculation apparatus, which further includes:
in some optional implementations, the preset expense calculation task includes at least one selected from a group consisting of a labor expense calculation task, a project fund calculation task, and a royalty calculation task.

The above descriptions are merely preferred embodiments of the present disclosure and illustrations of the technical principles employed. Those skilled in the art should understand that the scope of disclosure involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalents, such as technical solutions which are formed by replacing the above-mentioned technical features with the technical features disclosed in the present disclosure (but not limited to) with similar functions.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

Although the subject matter has been described in language specific to structural features and/or method logical actions, it should be understood that the subject matter defined in the appended claims is not necessarily limited to the specific features or actions described above. Rather, the specific features and actions described above are merely example forms of implementing the claims.

1. An expense calculation method, comprising:
acquiring a preset expense calculation task associated with a target business object, and determining at least one expense calculation task item from the preset expense calculation task;
reading data of an associated data item from a preset data table according to a preset calculation rule for the expense calculation task item; and
completing the expense calculation task item based on the data of the associated data item and in accordance with the preset calculation rule, to complete the preset expense calculation task.

2. The method according to claim 1, wherein the reading data of the associated data item from the preset data table according to the preset calculation rule for the expense calculation task item comprises:
reading target billing object consumption data associated with the expense calculation task item from a billing object consumption data statistical table according to the preset calculation rule.

3. The method according to claim 2, wherein the reading data of the associated data item from the preset data table according to the preset calculation rule for the expense calculation task item further comprises:
reading a data item associated with the expense calculation task item from a preset expense calculation constraint data table according to the preset calculation rule,
wherein the preset expense calculation constraint data table is a collection of calculation rule constraint data items determined based on expense calculation details specified in an expense calculation constraint file associated with the target business object.

4. The method according to claim 3, wherein the reading data of the associated data item from the preset data table according to the preset calculation rule for the expense calculation task item further comprises:
reading information of a billing object associated with the target business object from a preset billing object information table according to the preset calculation rule,
wherein the information of the billing object comprises billing attribute information of the billing object.

5. The method according to claim 2, wherein a process of determining the billing object consumption data statistical table comprises:
acquiring an original consumption record data table of each billing object;
performing statistics of valid consumption record data on original consumption record data in the original consumption record data table, respectively, based on a preset business scenario and a preset data statistical dimension; and
filling in preset list items in the billing object consumption data table based on statistical results of the valid consumption record data to obtain the billing object consumption data statistical table.

6. The method according to claim 1, wherein the acquiring the preset expense calculation task associated with the target business object, and determining at least one expense calculation task item from the preset expense calculation task comprises:
acquiring an expense calculation constraint file number associated with the target business object; and
querying the preset expense calculation task according to the expense calculation constraint file number, and determining at least one expense calculation task item from the preset expense calculation task,
wherein the expense calculation task item is an expense calculation task formula determined based on at least one constraint item specified in an expense calculation constraint file.

7. The method according to claim 1, further comprising:
summarizing expense data from expense calculation results of respective expense calculation task items to obtain an expense data summary result; and
pushing the expense data summary result to a data settlement processing entry or a data report processing entry.

8. The method according to claim 1, wherein the preset expense calculation task comprises at least one selected from a group consisting of a labor expense calculation task, a project fund calculation task, and a royalty calculation task.

9. (canceled)

10. An electronic device, comprising:
one or more processors; and
a storage apparatus, configured to store one or more programs,
wherein the one or more programs, when executed by the one or more processors, enables the one or more processors to implement an expense calculation method, and the expense calculation method comprises:
acquiring a preset expense calculation task associated with a target business object, and determining at least one expense calculation task item from the preset expense calculation task;
reading data of an associated data item from a preset data table according to a preset calculation rule for the expense calculation task item; and
completing the expense calculation task item based on the data of the associated data item and in accordance with the preset calculation rule, to complete the preset expense calculation task.

11. A non-transitory computer-readable storage medium, in which a computer program is stored, wherein the computer program, when executed by a processor, implements an expense calculation method, and the expense calculation method comprises:
acquiring a preset expense calculation task associated with a target business object, and determining at least one expense calculation task item from the preset expense calculation task;
reading data of an associated data item from a preset data table according to a preset calculation rule for the expense calculation task item; and
completing the expense calculation task item based on the data of the associated data item and in accordance with the preset calculation rule, to complete the preset expense calculation task.

12. (canceled)

13. The method according to claim 3, wherein a process of determining the billing object consumption data statistical table comprises:
acquiring an original consumption record data table of each billing object;
performing statistics of valid consumption record data on original consumption record data in the original consumption record data table, respectively, based on a preset business scenario and a preset data statistical dimension; and
filling in preset list items in the billing object consumption data table based on statistical results of the valid consumption record data to obtain the billing object consumption data statistical table.

14. The method according to claim 4, wherein a process of determining the billing object consumption data statistical table comprises:
acquiring an original consumption record data table of each billing object;
performing statistics of valid consumption record data on original consumption record data in the original consumption record data table, respectively, based on a preset business scenario and a preset data statistical dimension; and
filling in preset list items in the billing object consumption data table based on statistical results of the valid consumption record data to obtain the billing object consumption data statistical table.

15. The method according to claim 2, wherein the acquiring the preset expense calculation task associated with the target business object, and determining at least one expense calculation task item from the preset expense calculation task comprises:
acquiring an expense calculation constraint file number associated with the target business object; and
querying the preset expense calculation task according to the expense calculation constraint file number, and determining at least one expense calculation task item from the preset expense calculation task,
wherein the expense calculation task item is an expense calculation task formula determined based on at least one constraint item specified in an expense calculation constraint file.

16. The method according to claim 3, wherein the acquiring the preset expense calculation task associated with the target business object, and determining at least one expense calculation task item from the preset expense calculation task comprises:
acquiring an expense calculation constraint file number associated with the target business object; and
querying the preset expense calculation task according to the expense calculation constraint file number, and determining at least one expense calculation task item from the preset expense calculation task,
wherein the expense calculation task item is an expense calculation task formula determined based on at least one constraint item specified in an expense calculation constraint file.

17. The method according to claim 4, wherein the acquiring the preset expense calculation task associated with the target business object, and determining at least one expense calculation task item from the preset expense calculation task comprises:
acquiring an expense calculation constraint file number associated with the target business object; and
querying the preset expense calculation task according to the expense calculation constraint file number, and determining at least one expense calculation task item from the preset expense calculation task,
wherein the expense calculation task item is an expense calculation task formula determined based on at least one constraint item specified in an expense calculation constraint file.

18. The method according to claim 5, wherein the acquiring the preset expense calculation task associated with the target business object, and determining at least one expense calculation task item from the preset expense calculation task comprises:
acquiring an expense calculation constraint file number associated with the target business object; and
querying the preset expense calculation task according to the expense calculation constraint file number, and determining at least one expense calculation task item from the preset expense calculation task,
wherein the expense calculation task item is an expense calculation task formula determined based on at least one constraint item specified in an expense calculation constraint file.

19. The method according to claim 2, further comprising:
summarizing expense data from expense calculation results of respective expense calculation task items to obtain an expense data summary result; and
pushing the expense data summary result to a data settlement processing entry or a data report processing entry.

20. The method according to claim 3, further comprising:
summarizing expense data from expense calculation results of respective expense calculation task items to obtain an expense data summary result; and
pushing the expense data summary result to a data settlement processing entry or a data report processing entry.

21. The method according to claim 4, further comprising:
summarizing expense data from expense calculation results of respective expense calculation task items to obtain an expense data summary result; and
pushing the expense data summary result to a data settlement processing entry or a data report processing entry.

22. The method according to claim 5, further comprising:
summarizing expense data from expense calculation results of respective expense calculation task items to obtain an expense data summary result; and
pushing the expense data summary result to a data settlement processing entry or a data report processing entry.
